(19) United States
(12) Patent Application Publication
(10) Pub. No.: US 2024/0425047 A1
(43) Pub. Date: Dec. 26, 2024

(54) APPARATUS FOR CONTROLLING AUTONOMOUS DRIVING AND A METHOD THEREOF

(71) Applicants: HYUNDAI MOTOR COMPANY, Seoul (KR); KIA CORPORATION, Seoul (KR)

(72) Inventors: In Ho Kim, Seoul (KR); Kyoung Jun Lee, Seoul (KR)

(73) Assignees: HYUNDAI MOTOR COMPANY, Seoul (KR); KIA CORPORATION, Seoul (KR)

(21) Appl. No.: 18/504,793

(22) Filed: Nov. 8, 2023

(30) Foreign Application Priority Data
Jun. 20, 2023 (KR) 10-2023-0079184

(51) Int. Cl. B60W 30/14; B60W 50/16; B60W 60/00

(52) U.S. Cl. CPC B60W 30/146; B60W 50/16; B60W 60/001; B60W 2050/146; B60W 2552/05; B60W 2555/60; B60W 2720/10

(57) ABSTRACT

An autonomous driving control apparatus includes a sensor device, a notification device, a memory, and a control device. The autonomous driving control apparatus identifies situation information about at least one target control item for the host vehicle by using the sensor device. The autonomous driving control apparatus also determines whether the at least one target control item is capable of being performed based on the situation information or whether an advance warning regarding the situation information is required. The autonomous driving control apparatus also provides at least one notification to the user by using the notification device when it is determined that the at least one target control item is incapable of being performed or the advance warning regarding the situation information is required.

### CROSS-REFERENCE TO RELATED APPLICATION

This application claims the benefit of and priority to Korean Patent Application No. 10-2023-0079184, filed in the Korean Intellectual Property Office on Jun. 20, 2023, the entire contents of which are incorporated herein by reference.

### TECHNICAL FIELD

The present disclosure relates to an autonomous driving control apparatus and a method thereof, and more particularly, relates to a technology for providing a user with a notification about a driving situation.

### BACKGROUND

As autonomous driving vehicles are gradually spread, various technologies related to autonomous driving are being developed. The autonomous driving may be divided into partial autonomous driving, conditional autonomous driving, highly autonomous driving, and/or fully autonomous driving depending on a control level.

In the meantime, among autonomous driving control functions, various types of control algorithms (or functions) for driving control of a host vehicle are being developed.

For example, on the basis of smart cruise control (SCC), an autonomous driving control apparatus may maintain an inter-vehicle distance by using at least one of a relative distance between a host vehicle and another vehicle (e.g., a preceding vehicle driving in front of the host vehicle), speed, acceleration, or any combination thereof. The autonomous driving control apparatus may provide a function of setting and controlling the driving speed of the host vehicle.

For example, an autonomous driving control apparatus may perform driving control of a host vehicle through SCC based on information obtained using various types of components. For example, the autonomous driving control apparatus may identify at least one of information about a specific point in a forward area of the host vehicle, information about a specific section (e.g., speed limit), or any combination thereof based on navigation information obtained through a navigation system. The autonomous driving control apparatus may control the driving speed (e.g., a longitudinal speed) of the host vehicle through the identification result. The SCC function based on such navigation information may be defined as navigation-based smart cruise control (NSCC).

However, when an uncontrollable control item is identified or a situation that a user needs to perceive occurs while the driving control of the host vehicle is performed based on NSCC, the provision of a notification function needs to be perceived in advance. Due to the absence of an algorithm for providing a notification function, the user may experience inconvenience or may encounter a dangerous situation.

### SUMMARY

The present disclosure has been made to solve the above-mentioned problems occurring in the prior art while advantages achieved by the prior art are maintained intact.

In embodiments of the present disclosure, an autonomous driving control apparatus may identify situation information about at least one target control item for a host vehicle. The autonomous driving control apparatus may also identify whether the target control item is capable of being executed based on the situation information. The autonomous driving control apparatus may also provide a notification to a user when it is identified the target control item is incapable of being executed.

According to an embodiment of the present disclosure, an autonomous driving control apparatus may identify situation information about at least one target control item for the host vehicle. The autonomous driving control apparatus may also determine whether advance regarding the situation information is required, based on the situation information. The autonomous driving control apparatus may also provide a notification to the user when it is determined that the advance warning is required.

According to an embodiment of the present disclosure, when identifying that longitudinal speed control is required while the host vehicle is driving in a speed enforcement section, an autonomous driving control apparatus may determine whether an advance warning notification is required, by using a sensor device based on various pieces of information about speed control section and host vehicle.

According to an embodiment of the present disclosure, an autonomous driving control apparatus may provide the user with an advance warning notification including information about a road type change, when identifying that the type of a road, on which the host vehicle is driving, is changed within a specified distance.

According to an embodiment of the present disclosure, an autonomous driving control apparatus may provide, by using a notification device, a notification including locations of start and end points of a speed enforcement section, a real-time location of the host vehicle, a real-time driving speed of the host vehicle, a speed limit, a guide on a transition of control authority for the host vehicle, a first road type of driving road, a specified distance, a real-time distance remaining until a type is changed, a second road type of a forward road, or any combination thereof.

The technical problems to be solved by the present disclosure are not limited to the aforementioned problems. Any other technical problems not mentioned herein should be clearly understood from the following description by those having ordinary skill in the art to which the present disclosure pertains.

According to an aspect of the present disclosure, an autonomous driving control apparatus includes a sensor device, a notification device, a memory configured to store instructions, and a control device operatively connected to the sensor device, the notification device, and the memory. The instructions, when executed by the control device, causes the autonomous driving control apparatus to identify situation information about at least one target control item for the host vehicle by using the sensor device. The instructions, when executed by the control device, causes the autonomous driving control apparatus to determine whether the at least one target control item is capable of being performed based on the situation information or whether an advance warning regarding the situation information is required. The instructions, when executed by the control device, causes the autonomous driving control apparatus to provide at least one notification to the user by using the notification device when it is determined that the at least one target control item is incapable of being performed or the advance warning regarding the situation information is required.

According to an embodiment, the instructions, when executed by the control device, may cause the autonomous driving control apparatus to determine whether the at least one target control item is capable of being performed based on navigation-based smart cruise control (NSCC).

According to an embodiment, the instructions, when executed by the control device, may cause the autonomous driving control apparatus to identify the situation information about the at least one target control item including the longitudinal speed control while controlling driving of the host vehicle, when it is identified that longitudinal speed control is required.

According to an embodiment, the instructions, when executed by the control device, may cause the autonomous driving control apparatus to identify the situation information including at least one of a starting point and an endpoint of the speed enforcement section, a real-time location of the host vehicle, a lowest target speed of the host vehicle through NSCC control, or a combination of the starting point and the endpoint of the speed enforcement section, the real-time location of the host vehicle, and the lowest target speed of the host vehicle through the NSCC control when identifying that the host vehicle is driving in a speed enforcement section. The instructions, when executed by the control device, may also cause the autonomous driving control apparatus to identify whether NSCC-based control is possible such that a driving speed of the host vehicle at the endpoint is less than a speed limit of the speed enforcement section, based on the situation information. The instructions, when executed by the control device, may also cause the autonomous driving control apparatus to provide a first notification to the user by using the notification device when it is determined that the control is impossible.

According to an embodiment, the instructions, when executed by the control device, may cause the autonomous driving control apparatus to identify the speed limit of the speed enforcement section and to identify a speed corresponding to a specified ratio of the speed limit as the lowest target speed of the host vehicle.

According to an embodiment, the first notification may include at least one of locations of the starting point and the endpoint of the speed enforcement section, the real-time location of the host vehicle, a real-time driving speed of the host vehicle, the speed limit, a guide on a transition of control authority for the host vehicle, or a combination of the locations of the starting point and the endpoint of the speed enforcement section, the real-time location of the host vehicle, the real-time driving speed of the host vehicle, the speed limit, and the guide on the transition of the control authority for the host vehicle.

According to an embodiment, the instructions, when executed by the control device, may cause the autonomous driving control apparatus to identify a first road type of a driving road on which the host vehicle is driving. The instructions, when executed by the control device, may also cause the autonomous driving control apparatus to provide a second notification to the user by using the notification device when it is identified that a second road type of a front road placed within a specified distance from a real-time location of the host vehicle is different from the first road type of the driving road.

According to an embodiment, the second notification may include at least one of the first road type of the driving road, the specified distance, a real-time distance remaining until the first road type is changed, the second road type of the front road, a real-time location of the host vehicle, a real-time driving speed of the host vehicle, a guide on a transition of control authority for the host vehicle, or a combination of the first road type of the driving road, the specified distance, the real-time distance remaining until the first road type is changed, the second road type of the front road, the real-time location of the host vehicle, the real-time driving speed of the host vehicle, and the guide on the transition of control authority for the host vehicle.

According to an embodiment, the instructions, when executed by the control device, may cause the autonomous driving control apparatus to determine whether NSCC based on navigation information is being performed on the host vehicle when it is determined that the at least one target control item is incapable of being performed or the advance warning regarding the situation information is required. The instructions, when executed by the control device, may also cause the autonomous driving control apparatus to provide the at least one notification to the user by using the notification device when it is identified that the NSCC is being performed.

According to an embodiment, the instructions, when executed by the control device, may cause the autonomous driving control apparatus to provide the user with the at least one notification including at least one of visual content, auditory content, a haptic function, or a combination of the visual content, the auditory content, and the haptic function by using the notification device.

According to an aspect of the present disclosure, an autonomous driving control method may include identifying, by a control device, situation information about at least one target control item for a host vehicle by using a sensor device. The autonomous driving control method may also include determining, by the control device, whether the at least one target control item is capable of being performed based on the situation information or whether an advance warning regarding the situation information is required. The autonomous driving control method may also include providing, by the control device, at least one notification to a user by using a notification device when it is determined that the at least one target control item is incapable of being performed or the advance warning regarding the situation information is required.

According to an embodiment, determining, by the control device, whether the at least one target control item is capable of being performed based on the situation information or whether the advance warning regarding the situation information is required may further include determining, by the control device, whether the at least one target control item is capable of being performed based on NSCC.

According to an embodiment, identifying, by the control device, the situation information about the at least one target control item for the host vehicle by using the sensor device may further include identifying, by the control device, the situation information about the at least one target control item including the longitudinal speed control while controlling driving of the host vehicle, when it is identified that longitudinal speed control is required.

According to an embodiment, the autonomous driving control method may further include identifying, by the control device, the situation information including at least one of a starting point and an endpoint of the speed enforcement section, a real-time location of the host vehicle, a lowest target speed of the host vehicle through NSCC control, or a combination of the starting point and the endpoint of the speed enforcement section, the real-time location of the host vehicle, and the lowest target speed of the host vehicle through the NSCC control when identifying that the host vehicle is driving in a speed enforcement section. The autonomous control method may further include identifying, by the control device, whether NSCC-based control is possible such that a driving speed of the host vehicle at the endpoint is less than a speed limit of the speed enforcement section, based on the situation information. The autonomous driving control method may further include providing, by the control device, a first notification to the user by using the notification device when it is determined that the control is impossible.

According to an embodiment, identifying, by the control device, the lowest target speed of the host vehicle through the NSCC control may further include identifying, by the control device, the speed limit of the speed enforcement section and identifying, by the control device, a speed corresponding to a specified ratio of the speed limit as the lowest target speed of the host vehicle.

According to an embodiment, the first notification may include at least one of locations of the starting point and the endpoint of the speed enforcement section, the real-time location of the host vehicle, the real-time driving speed of the host vehicle, the speed limit, a guide on a transition of control authority for the host vehicle, or a combination of the locations of the starting point and the endpoint of the speed enforcement section, the real-time location of the host vehicle, the real-time driving speed of the host vehicle, the speed limit, and the guide on the transition of the control authority for the host vehicle.

According to an embodiment, the autonomous driving control method may further include identifying, by the control device, a first road type of a driving road on which the host vehicle is driving. The autonomous driving control method may further include providing, by the control device, a second notification to the user by using the notification device when it is identified that a second road type of a front road placed within a specified distance from a real-time location of the host vehicle is different from the first road type of the driving road.

According to an embodiment, the second notification may include at least one of the first road type of the driving road, the specified distance, a real-time distance remaining until the first road type is changed, the second road type of the front road, a real-time location of the host vehicle, a real-time driving speed of the host vehicle, a guide on a transition of control authority for the host vehicle, or a combination of the first road type of the driving road, the specified distance, the real-time distance remaining until the first road type is changed, the second road type of the front road, the real-time location of the host vehicle, the real-time driving speed of the host vehicle, and the guide on the transition of control authority for the host vehicle.

According to an embodiment, the autonomous driving control method may further include determining, by the control device, whether NSCC based on navigation information is being performed on the host vehicle when it is determined that the at least one target control item is incapable of being performed or the advance warning regarding the situation information is required. The autonomous driving control method may further include providing, by the control device, the at least one notification to the user by using the notification device when it is identified that the NSCC is being performed.

According to an embodiment, the autonomous driving control method may further include providing, by the control device, the user with the at least one notification including at least one of visual content, auditory content, a haptic function, or a combination of the visual content, the auditory content, and the haptic function by using the notification device.

### BRIEF DESCRIPTION OF THE DRAWINGS

The above and other objects, features, and advantages of the present disclosure should be more apparent from the following detailed description taken in conjunction with the accompanying drawings:

FIG. 1 is a block diagram showing components of an autonomous driving control apparatus, according to an embodiment of the present disclosure;

FIG. 2 is a block diagram showing components of an autonomous driving control apparatus, according to an embodiment of the present disclosure;

FIG. 3 is a conceptual diagram illustrating an operation of an autonomous driving control apparatus, according to an embodiment of the present disclosure;

FIG. 4 is a conceptual diagram illustrating an operation of an autonomous driving control apparatus, according to an embodiment of the present disclosure;

FIG. 5 is an operation flowchart of an autonomous driving control apparatus, according to an embodiment of the present disclosure; and

FIG. 6 is an operation flowchart of an autonomous driving control apparatus, according to an embodiment of the present disclosure.

With regard to description of drawings, the same or similar components are marked by the same or similar reference signs.

### DETAILED DESCRIPTION

Hereinafter, some embodiments of the present disclosure are described in detail with reference to the accompanying drawings. In the drawings, the same reference numerals are used throughout to designate the same or equivalent elements. In addition, a detailed description of well-known features or functions has been omitted in order not to unnecessarily obscure the gist of the present disclosure.

In describing elements of an embodiment of the present disclosure, the terms first, second, A, B, (a), (b), and the like may be used herein. These terms are only used to distinguish one element from another element but do not limit the corresponding elements irrespective of the order or priority of the corresponding elements. Furthermore, unless otherwise defined, all terms including technical and scientific terms used herein should be interpreted as is customary in the art to which the present disclosure belongs. It should be understood that terms used herein should be interpreted as having a meaning that is consistent with their meaning in the context of the present disclosure and the relevant art and should not be interpreted in an idealized or overly formal sense unless expressly so defined herein. When a component, device, element, or the like of the present disclosure is described as having a purpose or performing an operation, function, or the like, the component, device, element, or the like should be considered herein as being “configured to” meet that purpose or to perform that operation or function. Each of the component, device, element, and the like may separately embody or be included with a processor and a memory, such as a non-transitory computer readable media, as part of the apparatus.

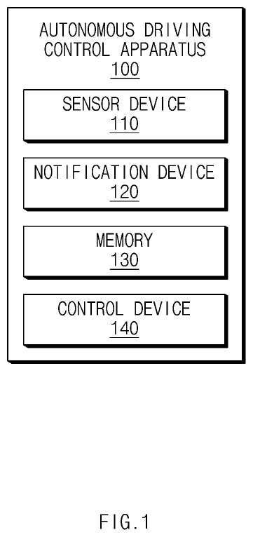

Hereinafter, various embodiments of the present disclosure are described in detail with reference to FIGS. 1-6.

FIG. 1 is a block diagram showing components of an autonomous driving control apparatus, according to an embodiment of the present disclosure.

According to an embodiment, an autonomous driving control apparatus 100 may include at least one of a sensor device 110, a notification device 120, a memory 130, a control device 140, or any combination thereof. The configuration of the autonomous driving control apparatus 100 shown in FIG. 1 is an example, and embodiments of the present disclosure are not limited thereto. For example, the autonomous driving control apparatus 100 may further include components (e.g., at least one of an interface device, a communication device, a display device, or any combination thereof) not shown in FIG. 1.

According to an embodiment, the sensor device 110 may obtain (or identify) various pieces of information (e.g., information including at least one of biometric information of a user, internal information of a host vehicle, driving environment information, or any combination thereof) used for the driving of a host vehicle.

In one embodiment, the sensor device 110 may include at least one sensor including at least one of a camera, radar, LiDAR, or any combination thereof.

In another embodiment, the sensor device 110 may further include a navigation system. In one embodiment, the control device 140 may perform driving control (e.g., Navigation-based Smart Cruise Control (NSCC)) on a host vehicle by using navigation information identified by using the navigation system.

In one embodiment, the sensor device 110 may identify situation information about at least one target control item for the host vehicle.

For example, when it is identified that driving control (e.g., longitudinal speed control) for the host vehicle is required in a situation where the host vehicle is being driven under control (e.g., control based on NSCC) of the autonomous driving control apparatus 100, the sensor device 110 may identify situation information about at least one target control item including longitudinal speed control.

For example, when it is identified that the host vehicle is driving in the speed enforcement section, the sensor device 110 may identify situation information including at least one of start and end points of the speed enforcement section, a real-time location of the host vehicle, the lowest target speed of the host vehicle through NSCC control, or any combination thereof.

In one embodiment, the sensor device 110 may obtain information by using at least one sensor and may identify the information obtained based on other external components (e.g., a communication device).

For example, the sensor device 110 may identify driving environment information including information about at least one of a driving speed of the host vehicle, a driving acceleration of the host vehicle, a driving direction of the host vehicle, a destination of the host vehicle, a driving route of the host vehicle, a driving mode of the host vehicle, a driving road of the host vehicle, a real-time location of the host vehicle, a real-time remaining distance to a specific point, an area adjacent to the host vehicle, or any combination thereof.

In one embodiment, the sensor device 110 may identify information about a first road type of a driving road on which the host vehicle is driving.

In another embodiment, the sensor device 110 may identify a second road type of a forward road placed within a specified distance (e.g., 200 m) from the real-time location of the host vehicle.

According to an embodiment, the notification device 120 may include various types of alarm providing devices and may provide a user with a notification including information about driving control of a host vehicle by using the alarm providing devices.

For example, the notification device 120 may include a display. In one embodiment, the autonomous driving control apparatus 100 may provide a user with a notification including visual content and/or auditory content through the display.

For example, the notification device 120 may include an audio output device. For example, the autonomous driving control apparatus 100 may provide a user with a notification including auditory content through the audio output device.

In one embodiment, the notification device 120 may include a haptic device (e.g., a vibration device). For example, the autonomous driving control apparatus 100 may provide the user with a notification including a haptic function through the haptic device. For example, the haptic device may include at least one device that provides the user with vibration through at least one of at least one seat, at least one belt, at least one steering wheel, or any combination thereof in the host vehicle.

According to an embodiment, the memory 130 may store instructions or data. For example, the memory 130 may store one or more instructions that cause the autonomous driving control apparatus 100 to perform various operations when executed by the control device 140.

For example, the memory 130 and the control device 140 may be implemented as one chipset. The control device 140 may include at least one of a communication processor or a modem.

For example, the memory 130 may store various pieces of information related to the autonomous driving control apparatus 100. For example, the memory 130 may store information about the operation history of the control device 140. For example, the memory 130 may store information related to states and/or operations of components (e.g., at least one of an engine control unit (ECU), the sensor device 110, the notification device 120, the control device 140, or any combination thereof) of the host vehicle.

According to an embodiment, the controller 140 may be operatively connected to the sensor device 110, the notification device 120, and/or the memory 130. For example, the control device 140 may control operations of the sensor device 110, the notification device 120, and/or the memory 130.

For example, the control device 140 may identify situation information about at least one target control item for the host vehicle by using the sensor device 110.

For example, the control device 140 may determine whether at least one target control item for the host vehicle is capable of being executed based on NSCC, based on the situation information identified by using the sensor device 110.

For example, when it is identified that longitudinal speed control is required while the control device 140 controls the driving of the host vehicle, the control device 140 may identify situation information about at least one target control item including the longitudinal speed control.

For example, when identifying that the host vehicle is driving in the speed enforcement section, the control device 140 may identify situation information including at least one of start and end points of the speed enforcement section, the real-time location of the host vehicle, the lowest target speed of the host vehicle through NSCC control, or any combination thereof, by using the sensor device 140.

For example, the control device 140 may identify a speed limit of a speed enforcement section by using a navigation system included in the sensor device 110. The control device 140 may identify that a speed corresponding to a specified ratio (e.g., 90%) of the speed limit of the speed enforcement section is the lowest target speed of the host vehicle. For example, when the speed limit in the speed enforcement section is 100 km/h, the control device 140 may identify that the lowest target speed is 90 km/h. For example, when the host vehicle in the corresponding section is controlled, the lowest target speed may be the lowest value among controllable driving speeds of a host vehicle by the control device 140.

For example, the control device 140 may identify a first road type of a driving road on which the host vehicle is driving, by using the sensor device 110.

For example, the control device 140 may identify a second road type of a forward road placed within a specified distance (e.g., 200 m) from the real-time location of the host vehicle by using the sensor device 110. Numerical values for the specified distance are examples, and embodiments of the present disclosure are not limited thereto.

For example, the control device 140 may determine whether the at least one target control item is capable of being performed on the basis of situation information or whether an advance warning regarding the situation information is required.

For example, the control device 140 may determine whether at least one target control item is capable of being executed based on NSCC.

For example, when identifying that the host vehicle is driving within the speed enforcement section, the control device 140 may identify the situation information including at least one of start and end points of the speed enforcement section, a real-time location of the host vehicle, the lowest target speed of the host vehicle through NSCC control, or any combination thereof. When identifying that the host vehicle is driving within the speed enforcement section, the control device 140 may also identify whether NSCC-based control is possible such that the driving speed of the host vehicle at the end point is less than the speed limit of the speed enforcement section, based on the situation information.

For example, when it is determined that at least one target control item is incapable of being executed or an advance warning regarding the situation information is required, the control device 140 may provide at least one notification to the user by using the notification device 120.

For example, when it is determined that at least one target control item is incapable of being executed or an advance warning regarding the situation information is required, the control device 140 may determine whether NSCC based on navigation information is being performed on the host vehicle. When it is identified that the NSCC is being performed, the control device 140 may provide a notification to the user by using the notification device 120. In other words, only while performing control of the host vehicle based on NSCC, the control device 140 may perform a notification providing function using the notification device 120.

For example, when it is determined that at least one target control item is incapable of being executed or an advance warning regarding the situation information is required, the control device 140 may provide at least one notification to the user by using the notification device 120.

For example, the control device 140 may identify whether NSCC-based control is possible such that the driving speed of the host vehicle at an endpoint is less than the speed limit of the speed enforcement section, based on the situation information. When it is determined that the control is impossible, the control device 140 may provide a first notification to the user by using the notification device 120.

For example, the first notification may include at least one of locations of start and end points of the speed enforcement section, a real-time location of the host vehicle, a real-time driving speed of the host vehicle, a speed limit, a guide on a transition of control authority for the host vehicle, or any combination thereof.

For example, the control device 140 may identify the first road type of the driving road on which the host vehicle is driving. When it is identified that the second road type of a front road placed within a specified distance (e.g., 200 m) from a real-time location of the host vehicle is different from the first road type of the driving road, the control device 140 may provide a second notification to the user by using the notification device 120. For example, if the control unit 140 identifies that the second road type is one of the road types that cannot control its own vehicle based on a specified operating mode (e.g., Smart Cruise Control (SCC) and/or Navigation-based Smart Cruise Control (NSCC), the control device 140 may provide a second notification to the user by using the notification device 120.

For example, the second notification may include at least one of a first road type of a driving road, a specified distance, a real-time distance remaining until a road type is changed, a second road type of a front road, a real-time location of the host vehicle, a real-time driving speed of the host vehicle, a guide on a transition of control authority for the host vehicle, or any combination thereof.

For example, the control device 140 may provide the user with at least one notification including at least one of visual content, auditory content, a haptic function, or any combination thereof by using the notification device 120. The at least one notification may include, for example, the first notification and/or the second notification.

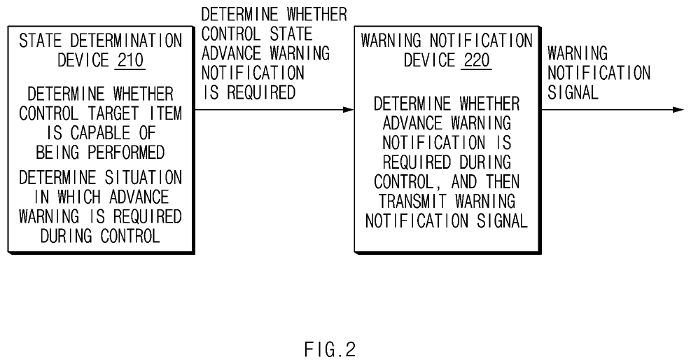

FIG. 2 is a block diagram showing components of an autonomous driving control apparatus, according to an embodiment of the present disclosure.

According to an embodiment, autonomous driving control apparatus (e.g., the autonomous driving control apparatus 100 of FIG. 1) may include a state determination device 210 and/or a warning notification device 220 (e.g., the notification device 120 in FIG. 1).

The structure of components shown in FIG. 2 is an example, and embodiments of the present disclosure are not limited thereto. For example, in FIG. 2, the state determination device 210 and/or the warning notification device 220 may be implemented as a part of the control device 140 and the sensor device 110 of FIG. 1 or may be implemented as a single chip with the control device 140. In other words, at least part of operations of the state determination device 210 and/or the warning notification device 220, which is described below, may be performed by the control device 140 and/or the sensor device 110 of FIG. 1 (or under control of the control device 230).

For example, the state determination device 210 may determine whether the control target item is capable of being executed and/or may determine a situation in which an advance warning is required during driving control for the host vehicle.

For example, the state determination device 210 may identify situation information about at least one target control item for the host vehicle and may determine whether at least one target control item is capable of being executed, based on the situation information.

For example, the state determination device 210 may determine whether the advance warning is required, based on the situation information.

For example, the state determination device 210 may transmit whether a control state and/or an advance warning notification are required, to the warning notification device 220.

For example, the warning notification device 220 may determine whether an advance warning notification is required during control. When it is determined that the advance warning notification is required, the warning notification device 220 may transmit a warning notification signal.

For example, the warning notification device 220 may deliver the warning notification signal to various types of notification devices (e.g., at least one of a display, an audio output device, a haptic device, or any combination thereof) installed in the host vehicle.

For example, the warning notification device 220 may deliver a warning notification signal including content of at least one notification including a first notification and a second notification, included information, or the like to a notification device (e.g., the notification device 120 of FIG. 1).

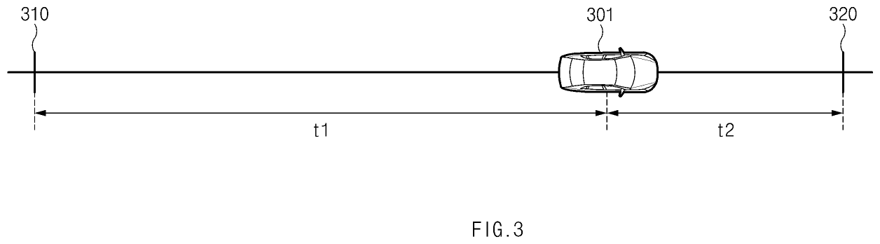

FIG. 3 is a conceptual diagram illustrating an operation of an autonomous driving control apparatus, according to an embodiment of the present disclosure.

According to an embodiment, a host vehicle 301 according to FIG. 3 may be defined as a driving situation under control of an autonomous driving control apparatus (e.g., the autonomous driving control apparatus 100 in FIG. 1). An operation of the host vehicle 301 to be described below may be defined as an operation under control of an autonomous driving control apparatus. In other words, an operation of the host vehicle 301 to be described below may include a driving control (e.g., NSCC) operation of the autonomous driving control apparatus.

According to an embodiment, the host vehicle 301 may identify situation information about at least one target control item. For example, when it is identified that longitudinal speed control is required, the host vehicle 301 may identify situation information about at least one target control item including the longitudinal speed control.

For example, when it is identified that the host vehicle 301 is driving in a speed enforcement section shown in FIG. 3, the host vehicle 301 may identify situation information about a driving state of the host vehicle 301 and/or the speed enforcement section.

For example, when it is identified that the host vehicle 301 is driving in the speed enforcement section, the situation information may include at least one of start and end points of the speed enforcement section, a real-time location of the host vehicle 301, the lowest target speed of the host vehicle 301 through NSCC control, or any combination thereof.

For example, the host vehicle 301 may identify that the host vehicle 301 is currently driving by moving by a first distance t1 from a starting point 310 of the speed enforcement section.

For example, the host vehicle 301 may identify that the host vehicle 301 is currently driving in a state remaining by a second distance t2 from an endpoint 320 of the speed enforcement section.

For example, on the basis of the situation information, the host vehicle 301 may identify whether NSCC control is possible such that the driving speed of the host vehicle at the endpoint 320 is less than the speed limit of the speed enforcement section.

For example, the host vehicle 301 may identify the speed limit of the speed enforcement section by using at least one of situation information, sensing information obtained through a sensor device, or any combination thereof. The host vehicle 301 may also identify a speed corresponding to a specified ratio (e.g., 90%) of the speed limit as the lowest target speed of the host vehicle.

For example, when the host vehicle 301 reaches the endpoint 320, the host vehicle 301 may identify whether the host vehicle 301 is capable of driving at a speed less than a speed limit, by performing control based on the lowest target speed from the current location.

For example, when it is identified that NSCC control, which enables the driving speed of the host vehicle at the endpoint 320 to be less than the speed limit of the speed enforcement section, is impossible, the host vehicle 301 may provide a first notification to the user by using a notification device.

For example, the first notification may include at least one of locations of the starting point 310 and the endpoint 320 of the speed enforcement section, a real-time location of the host vehicle 301, a real-time driving speed of the host vehicle 301, a speed limit, a guide on a transition of control authority for the host vehicle 301, or any combination thereof.

For example, the guide on the transition of control authority may include guide information that allows a user to perform driving control of the host vehicle (e.g., to start driving in a manual mode).

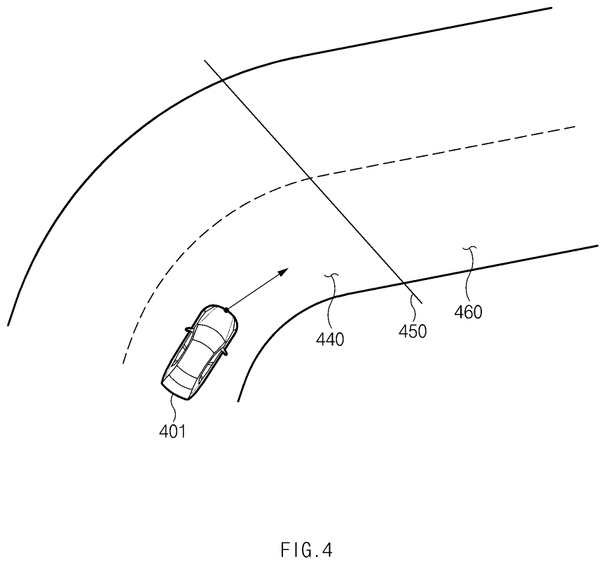

FIG. 4 is a conceptual diagram illustrating an operation of an autonomous driving control apparatus, according to an embodiment of the present disclosure.

According to an embodiment, a host vehicle 401 according to FIG. 4 may be defined as a driving situation under control of an autonomous driving control apparatus (e.g., the autonomous driving control apparatus 100 in FIG. 1). An operation of the host vehicle 401 to be described below may be defined as an operation under control of an autonomous driving control apparatus. In other words, an operation of the host vehicle 401 to be described below may include a driving control (e.g., NSCC) operation of the autonomous driving control apparatus.

According to an embodiment, the host vehicle 401 may identify a road type of a driving road. For example, when the road type of the driving road is identified, the host vehicle 401 may identify that a road having a type different from the identified road type identified within a specified distance ahead.

For example, the host vehicle 401 may identify a first road type of a current driving road 440 shown in FIG. 4.

For example, the first road type may be an interchange (IC) or a junction (JC), but this is an example. Embodiments of the present disclosure are not limited thereto. The first road type may be, for example, a highway and/or an express road.

For example, the host vehicle 401 may identify a second road type of a front road 460 placed within a specified distance (e.g., 200 m) from the real-time location of the host vehicle 401 being driven on the driving road 440.

For example, the host vehicle 401 may identify a boundary 450 between the driving road 440 and the front road 460 according to FIG. 4.

For example, the second road type may be a national highway, but this is an example, Embodiments of the present disclosure are not limited thereto. For example, the second road type may be a main line, IC, or JC.

For example, when it is identified that the second road type of the front road 460 is different from the first road type of the driving road 440, the host vehicle 401 may provide a second notification to the user by using a notification device (e.g., the notification device 120 in FIG. 1). For example, if the autonomous driving control apparatus identifies that the second road type is one of the road types that cannot control its own vehicle based on a specified operating mode (e.g., Smart Cruise Control (SCC) and/or Navigation-based Smart Cruise Control (NSCC), the autonomous driving control apparatus may provide a second notification to the user by using the notification device.

For example, the second notification may include at least one of a road type of the driving road 440, a specified distance, a real-time distance remaining until a type is changed, a road type of the front road 460, a real-time location of the host vehicle 401, a real-time driving speed of the host vehicle 401, a guide on a transition of control authority for the host vehicle 401, or any combination thereof.

For example, the guide on the transition of control authority may include guide information that allows a user to perform driving control of the host vehicle (e.g., to start driving in a manual mode).

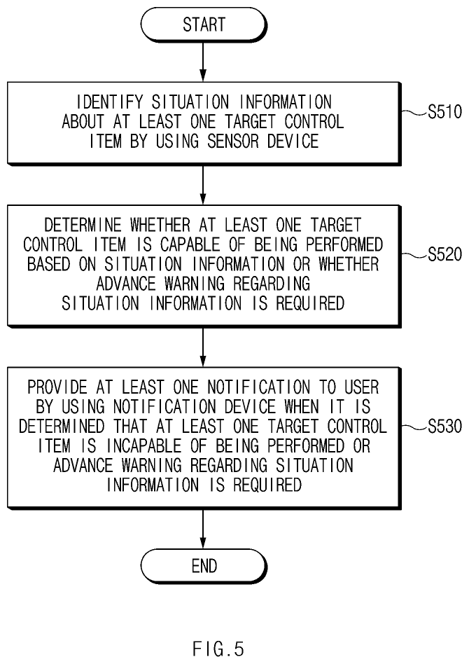

FIG. 5 is an operation flowchart of an autonomous driving control apparatus, according to an embodiment of the present disclosure.

According to an embodiment, an autonomous driving control apparatus (e.g., the autonomous driving control apparatus 100 of FIG. 1) may perform operations described in FIG. 5. For example, at least some of components (e.g., the sensor device 110, the notification device 120, the memory 130, and/or the control device 140 of FIG. 1) included in the autonomous driving control apparatus may be configured to perform the operations of FIG. 5.

In the following embodiment, S510 to S530 may be sequentially performed are not but always performed sequentially. For example, the order of operations may be changed, and at least two operations may be performed in parallel. Moreover, descriptions corresponding to or identical to the above-mentioned descriptions given with reference to FIG. 5 may be briefly described or omitted to avoid redundancy.

According to an embodiment, the autonomous driving control apparatus may identify situation information about at least one target control item by using a sensor device (S510).

For example, when it is identified that longitudinal speed control is required while the autonomous driving control apparatus controls the driving of the host vehicle, the autonomous driving control apparatus may identify situation information about at least one target control item including the longitudinal speed control.

For example, when it is identified that the host vehicle is driving in the speed enforcement section, the autonomous driving control apparatus may identify situation information including at least one of start and end points of the speed enforcement section, a real-time location of the host vehicle, the lowest target speed of the host vehicle through NSCC control, or any combination thereof.

For example, the autonomous driving control apparatus may identify the speed limit of the speed enforcement section and may identify a speed corresponding to a specified ratio of the speed limit as the lowest target speed of the host vehicle.

For example, the autonomous driving control apparatus may identify a first road type of a driving road on which the host vehicle is driving and/or a second road type of a front road placed within a specified distance from a real-time location of the host vehicle.

According to an embodiment, the autonomous driving control apparatus may determine whether the at least one target control item is capable of being performed on the basis of situation information or whether an advance warning regarding the situation information is required (S520).

For example, the autonomous driving control apparatus may determine whether at least one target control item is capable of being executed based on NSCC.

For example, when identifying that the host vehicle is driving within the speed enforcement section, the autonomous driving control apparatus may identify the situation information including at least one of start and end points of the speed enforcement section, a real-time location of the host vehicle, the lowest target speed of the host vehicle through NSCC control, or any combination thereof. When identifying that the host vehicle is driving within the speed enforcement section, the autonomous driving control apparatus may also identify whether NSCC-based control is possible such that the driving speed of the host vehicle at the end point is less than the speed limit of the speed enforcement section, based on the situation information.

For example, the autonomous driving control apparatus may determine whether the second road type of a front road placed within a specified distance from the real-time location of the host vehicle is different from the first road type of a driving road on which the host vehicle is currently driving.

For example, the autonomous driving control apparatus may determine whether the first road type is different from the second road type. For example, the first road type may include a road type where the autonomous driving control apparatus can control the host vehicle based on a specified operating mode (e.g., SCC (Smart Cruise Control) and/or NSCC (Navigation-based Smart Cruise Control). For example, the second road type may include one of the road type, unlike the first road type, where the autonomous driving control apparatus cannot control the host vehicle based on a specified operating mode (e.g., SCC (Smart Cruise Control) and/or NSCC (Navigation-based Smart Cruise Control).

According to an embodiment, when it is determined that at least one target control item is incapable of being executed or an advance warning regarding the situation information is required, the autonomous driving control apparatus may provide at least one notification to the user by using a notification device (S530).

For example, when it is identified that longitudinal speed control is required while the autonomous driving control apparatus controls the driving of the host vehicle, the autonomous driving control apparatus may identify situation information about at least one target control item including the longitudinal speed control.

For example, when it is determined that at least one target control item is incapable of being executed or an advance warning regarding the situation information is required, the autonomous driving control apparatus may determine whether NSCC based on navigation information is being performed on the host vehicle. When it is identified that the NSCC is being performed, the autonomous driving control apparatus may provide a notification to the user by using the notification device.

For example, the autonomous driving control apparatus may provide the user with at least one notification including at least one of visual content, auditory content, a haptic function, or any combination thereof by using the notification device.

For example, the at least one notification may include a first notification and/or a second notification.

For example, the first notification may include at least one of locations of start and end points of the speed enforcement section, a real-time location of the host vehicle, a real-time driving speed of the host vehicle, a speed limit, a guide on a transition of control authority for the host vehicle, or any combination thereof.

For example, the second notification may include at least one of a road type of a driving road, a specified distance, a real-time distance remaining 10 type is changed, a road type of a front road, a real-time location of the host vehicle, a real-time driving speed of the host vehicle, a guide on a transition of control authority for the host vehicle, or any combination thereof.

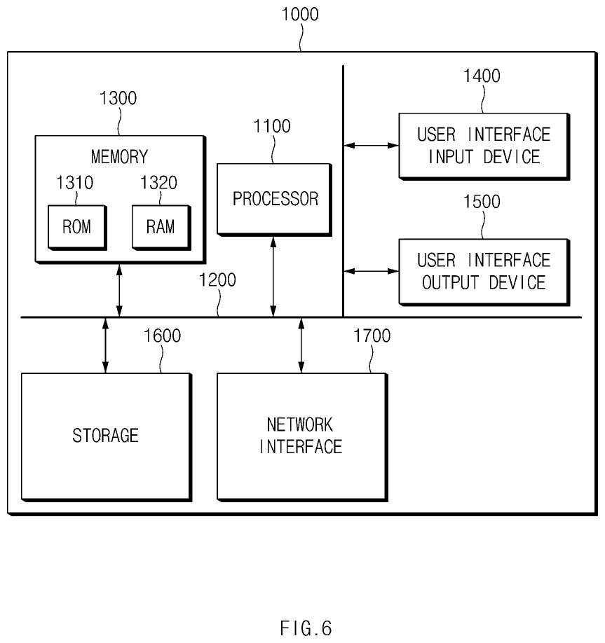

FIG. 6 illustrates a computing system related to an autonomous driving control method, according to an embodiment of the present disclosure.

Referring to FIG. 6, a computing system 1000 related to an autonomous driving control method may include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read only memory (ROM) and a random access memory (RAM).

Accordingly, the operations of the method or algorithm described in connection with the embodiments disclosed in the specification may be directly implemented with a hardware module, a software module, or a combination of the hardware module and the software module, which is executed by the processor 1100. The software module may reside on a storage medium (i.e., the memory 1300 and/or the storage 1600) such as a random access memory (RAM), a flash memory, a read only memory (ROM), an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

The above description is merely an example of the idea of the present disclosure, and various technical modifications and modifications may be made by one having ordinary skill in the art without departing from the essential characteristic of the present disclosure.

Accordingly, embodiments of the present disclosure are intended not to limit but to explain the technical idea of the present disclosure, and the scope and spirit of the present disclosure is not limited by the above embodiments. The scope of protection of the present disclosure should be construed by the attached claims, and all equivalents thereof should be construed as being included within the scope of the present disclosure.

An autonomous driving control apparatus according to an embodiment of the present disclosure and a method thereof are described as follows.

Moreover, according to at least one of embodiments of the present disclosure, when identifying a situation where driving control based on a specific control algorithm (e.g., NSCC) is impossible or difficult, an autonomous driving control apparatus may identify information about a situation before the situation occurs and then may perform a function of providing a user with a notification regarding the corresponding information in advance.

Moreover, according to at least one of embodiments of the present disclosure, an autonomous driving control apparatus may provide the user with information about a driving limit situation of a host vehicle in advance. Thus, usability including a function of providing information to a user may be increased, and the validity of driving control for a host vehicle including autonomous driving control may be secured.

Furthermore, according to at least one of embodiments of the present disclosure, when the continuity of driving control is inevitably interrupted due to a change in a surrounding environment while driving control for the host vehicle is being performed, an autonomous driving control apparatus may perform a function of providing information so as to cope with the corresponding situation in advance by providing the user with a warning notification in advance.

Besides, a variety of effects directly or indirectly understood through this disclosure may be provided.

Hereinabove, although the present disclosure has been described with reference to embodiments and the accompanying drawings, the present disclosure is not limited thereto. The present disclosure may be variously modified and altered by those having ordinary skill in the art to which the present disclosure pertains without departing from the spirit and scope of the present disclosure claimed in the following claims.

What is claimed is:

1. An autonomous driving control apparatus, the apparatus comprising:
a sensor device;
a notification device;
a memory configured to store instructions; and
a control device operatively connected to the sensor device, the notification device, and the memory,
wherein the instructions, when executed by the control device, cause the autonomous driving control apparatus to:
identify situation information about at least one target control item for a host vehicle by using the sensor device;
determine whether the at least one target control item is capable of being performed based on the situation information or whether an advance warning regarding the situation information is required; and
when it is determined that the at least one target control item is incapable of being performed or the advance warning regarding the situation information is required, provide at least one notification to a user by using the notification device.

2. The apparatus of claim 1, wherein the instructions, when executed by the control device, cause the autonomous driving control apparatus to:
determine whether the at least one target control item is capable of being performed based on navigation-based smart cruise control (NSCC).

3. The apparatus of claim 1, wherein the instructions, when executed by the control device, cause the autonomous driving control apparatus to:
while controlling driving of the host vehicle, when it is identified that longitudinal speed control is required, identify the situation information about the at least one target control item including the longitudinal speed control.

4. The apparatus of claim 1, wherein the instructions, when executed by the control device, cause the autonomous driving control apparatus to:
when identifying that the host vehicle is driving in a speed enforcement section, identify the situation information including at least one of a starting point and an endpoint of the speed enforcement section, a real-time location of the host vehicle, a lowest target speed of the host vehicle through NSCC control, combination of the starting point and the endpoint of the speed enforcement section, the real-time location of the host vehicle, and the lowest target speed of the host vehicle through the NSCC control;
identify whether NSCC-based control is possible such that a driving speed of the host vehicle at the endpoint is less than a speed limit of the speed enforcement section, based on the situation information; and
when it is determined that the control is impossible, provide a first notification to the user by using the notification device.

5. The apparatus of claim 4, wherein the instructions, when executed by the control device, cause the autonomous driving control apparatus to:
identify the speed limit of the speed enforcement section; and
identify a speed corresponding to a specified ratio of the speed limit as the lowest target speed of the host vehicle.

6. The apparatus of claim 4, wherein the first notification includes at least one of locations of the starting point and the endpoint of the speed enforcement section, the real-time location of the host vehicle, a real-time driving speed of the host vehicle, the speed limit, a guide on a transition of control authority for the host vehicle, or a combination of the locations of the starting point and the endpoint of the speed enforcement section, the real-time location of the host vehicle, the real-time driving speed of the host vehicle, the speed limit, and the guide on the transition of the control authority for the host vehicle.

7. The apparatus of claim 1, wherein the instructions, when executed by the control device, cause the autonomous driving control apparatus to:
identify a first road type of a driving road on which the host vehicle is driving; and
when it is identified that a second road type of a front road placed within a specified distance from a real-time location of the host vehicle is different from the first road type of the driving road, provide a second notification to the user by using the notification device.

8. The apparatus of claim 7, wherein the second notification includes at least one of the first road type of the driving road, the specified distance, a real-time distance remaining until the first road type is changed, the second road type of the front road, a real-time location of the host vehicle, a real-time driving speed of the host vehicle, a guide on a transition of control authority for the host vehicle, or a combination of the first road type of the driving road, the specified distance, the real-time distance remaining until the first road type is changed, the second road type of the front road, the real-time location of the host vehicle, the real-time driving speed of the host vehicle, and the guide on the transition of control authority for the host vehicle.

9. The apparatus of claim 1, wherein the instructions, when executed by the control device, cause the autonomous driving control apparatus to:
when it is determined that the at least one target control item is incapable of being performed or the advance warning regarding the situation information is required, determine whether NSCC based on navigation information is being performed on the host vehicle; and
when it is identified that the NSCC is being performed, provide the at least one notification to the user by using the notification device.

10. The apparatus of claim 1, wherein the instructions, when executed by the control device, cause the autonomous driving control apparatus to:
provide the user with the at least one notification including at least one of visual content, auditory content, a haptic function, or a combination of the visual content, the auditory content, and the haptic function by using the notification device.

11. An autonomous driving control method, the method comprising:
identifying, by a control device, situation information about at least one target control item for a host vehicle by using a sensor device;
determining, by the control device, whether the at least one target control item is capable of being performed based on the situation information or whether an advance warning regarding the situation information is required; and
when it is determined that the at least one target control item is incapable of being performed or the advance warning regarding the situation information is required, providing, by the control device, at least one notification to a user by using a notification device.

12. The method of claim 11, wherein determining whether the at least one target control item is capable of being performed based on the situation information or whether the advance warning regarding the situation information is required further includes:
determining, by the control device, whether the at least one target control item is capable of being performed based on NSCC.

13. The method of claim 12, wherein identifying the situation information about the at least one target control item for the host vehicle by using the sensor device further includes:
while controlling driving of the host vehicle, when it is identified that longitudinal speed control required, identifying, by the control device, the situation information about the at least one target control item including the longitudinal speed control.

14. The method of claim 11, further comprising:
when identifying that the host vehicle is driving in a speed enforcement section, identifying, by the control device, the situation information including at least one of a starting point and an endpoint of the speed enforcement section, a real-time location of the host vehicle, a lowest target speed of the host vehicle through NSCC control, or a combination of the starting point and the endpoint of the speed enforcement section, the real-time location of the host vehicle, and the lowest target speed of the host vehicle through the NSCC control;
identifying, by the control device, whether NSCC-based control is possible such that a driving speed of the host vehicle at the endpoint is less than a speed limit of the speed enforcement section, based on the situation information; and
when it is determined that the control is impossible, providing, by the control device, a first notification to the user by using the notification device.

15. The method of claim 14, wherein identifying the lowest target speed of the host vehicle through the NSCC control further includes:
identifying, by the control device, the speed limit of the speed enforcement section; and
identifying, by the control device, a speed corresponding to a specified ratio of the speed limit as the lowest target speed of the host vehicle.

16. The method of claim 14, wherein the first notification includes at least one of locations of the starting point and the endpoint of the speed enforcement section, the real-time location of the host vehicle, the real-time driving speed of the host vehicle, the speed limit, a guide on a transition of authority control for the host vehicle, or a combination of the locations of the starting point and the endpoint of the speed enforcement section, the real-time location of the host vehicle, the real-time driving speed of the host vehicle, the speed limit, and the guide on the transition of the control authority for the host vehicle.

17. The method of claim 11, further comprising:
identifying, by the control device, a first road type of a driving road on which the host vehicle is driving; and
when it is identified that a second road type of a front road placed within a specified distance from a real-time location of the host vehicle is different from the first road type of the driving road, providing, by the control device, a second notification to the user by using the notification device.

18. The method of claim 17, wherein the second notification includes at least one of the first road type of the driving road, the specified distance, a real-time distance remaining until the first road type is changed, the second road type of the front road, a real-time location of the host vehicle, a real-time driving speed of the host vehicle, a guide on a transition of control authority for the host vehicle, or a combination of the first road type of the driving road, the specified distance, the real-time distance remaining until the first road type is changed, the second road type of the front road, the real-time location of the host vehicle, the real-time driving speed of the host vehicle, and the guide on the transition of control authority for the host vehicle.

19. The method of claim 11, further comprising:
when it is determined that the at least one target control item is incapable of being performed or the advance warning regarding the situation information is required, determining, by the control device, whether NSCC based on navigation information is being performed on the host vehicle; and
when it is identified that the NSCC is being performed, providing, by the control device, the at least one notification to the user by using the notification device.

20. The method of claim 11, further comprising:
providing, by the control device, the user with the at least one notification including at least one of visual content, auditory content, a haptic function, or a combination of the visual content, the auditory content, and the haptic function by using the notification device.
